(19) United States
(12) Patent Application Publication
(10) Pub. No.: US 2004/0182682 A1
(43) Pub. Date: Sep. 23, 2004

(54) Extendable and retractable conveyor

(76) Inventor: Harold Glenn Chadwick, Jonesboro, AK (US)

Correspondence Address: JOHN S. PRATT, ESQ, KILPATRICK STOCKTON, LLP, 1100 PEACHTREE STREET, ATLANTA, GA, 30309, US

(21) Appl. No.: 10/392,728

(22) Filed: Mar. 18, 2003

(51) Int. Cl. B65G 13/12

(52) U.S. Cl. 198/588

(57) ABSTRACT

Extendable and retractable conveyors feature guide members whose cooperation is substantially limited to that necessary for guiding the conveyor during extension and retraction. The conveyor may be formed by several nestable conveyor segments. The guide members are mounted to, or formed by, different portions of the conveyor segments such that they slidably cooperate to guide the conveyor during extension and retraction in different environments without the conveyor jamming or binding.

### BACKGROUND

Extendable and retractable conveyors may be formed from at least two conveyor segments in which one segment can be extended and retracted with respect to the other segment. Typically, one of the conveyor segments may be of a size such that it can nest within another segment when the conveyor is at least partially retracted.

Extendable and retractable conveyors may be particularly useful to move packages and other items from one point to other points in a plant or warehouse, and in loading or unloading trucks, airplanes, or containers. It may sometimes be desirable to extend or retract a conveyor with minimum effort to a desired location, vehicle, or container. Also, it may sometimes be desirable to use extendable and retractable conveyors in environments where the floors or other surfaces are uneven or not completely flat.

One type of previous conveyor, such as the one disclosed in U.S. Pat. No. 6,068,111, issued May 20, 2000 to Smith et al. and entitled “Collapsible Feed Conveyor System,” which is incorporated herein by reference, is a conveyor formed from a plurality of nestable conveyor components which use channels or grooves for alignment. The components are slidably mounted to one another such as by T-shaped members, channels, or other telescoping structures on one component which are slidably mated to grooves or other cooperating structures on another component. The interaction of the channels, grooves, or other telescoping structures somewhat limits the movements of this type of conveyor to the directions of extension and retraction. Because these structures constrain, at least to some extent, movements not in the directions of extension and retraction, such conveyors may jam during extension and/or retraction, especially when used on uneven flooring or other uneven surfaces.

The telescoping structure type of conveyor may also be problematic because, among other things: (1) the components with channels, grooves, or other telescoping structures must necessarily be manufactured within narrow tolerances for the conveyor to extend and retract properly; (2) the telescoping structures are relatively time consuming and expensive to form; and (3) if the telescoping structures become damaged during use, such as when the conveyor jams during extension and/or retraction, the conveyor may not be able to extend and/or retract effectively, rendering the conveyor unusable until repaired.

An example of another type of previous conveyor is disclosed in U.S. Pat. No. 2,760,617, issued Aug. 28, 1956 to Bowen and entitled “Telescoping Conveyor,” which is incorporated herein by reference. These conveyors include a primary and secondary unit, which are slidably coupled to one another by means of lugs fixed to one of the units. The lugs slidably interact with flanges on the other unit to guide the longitudinal movement of the conveyor units relative to each other. This type of conveyor, however, is problematic in that the flanges may become jammed in the lugs during extension and/or retraction in a similar fashion as the telescoping type of conveyor. The lug-flange type conveyor may also be problematic in that if the lugs are damaged during use, such as when the conveyor jams during extension and/or retraction, the conveyor may not be able to extend and/or retract effectively, rendering the conveyor unusable until repaired.

### SUMMARY

Extendable and retractable conveyors according to various aspects and embodiments of the present invention may include at least two conveyor segments, at least one of which is movable relative to the other segment. Each segment may include at least one guide member. The cooperation of guide members on each segment may guide the extension and/or retraction of the conveyor in such a manner that the conveyor is less likely to jam.

For instance, according to various aspects and embodiments of the present invention, the cooperation of guide members on one conveyor segment with corresponding guide members on other conveyor segments may be substantially limited to the extent necessary to guide conveyor segments relative to each other during extension and retraction. For instance, the guide members are preferably not channeled relative to each other—that is, they do not form a channeled or telescoping structure that can bind, such as a telescoping radio antenna or conventional channels in extendable conveyors, from application of force in directions other than directions of extension and retraction. Consequently, the guide members, along with other portions of the conveyor segments, may move in some directions unrelated to guiding the extension and/or retraction of the conveyor without the conveyor jamming.

Some movements in directions unrelated to extension and retraction accommodated by various embodiments of conveyors according to the present invention may result from extending and/or retracting the conveyor on uneven surfaces. Additionally, some movements in directions unrelated to extension and retraction may result from extending or retracting the conveyor with the conveyor segments at an angle to each other. Other movements in directions unrelated to extension and retraction may result from forces commonly applied to extendable and retractable conveyors during ordinary use. Such forces can restrict the performance of such conveyors, by for instance, causing binding between conveyor components.

In some embodiments of the present invention, the conveyor segments may be formed such that one conveyor segment may be at least partially nested within another conveyor segment. At least one of the conveyor segments may include a conveyor bed supported by a plurality of legs. The legs may include casters at their bottom portions, or any other suitable structure, to facilitate movement of the conveyor segment. The conveyor bed may be formed from at least two side rails arranged in a generally parallel orientation to one another. However, it is not necessary that the two side rails be parallel to one another. The side rails may be spanned by a plurality of axles on which a plurality of skate wheels are rotatably mounted. Alternatively, a plurality of rollers, wheels, belts, or shafts may span the side rails.

Guide members according to certain aspects and embodiments of the present invention may be formed from rails, side rails, tubes, I-beams, legs, leg structures, structures attached to legs, angle irons, flat structures, one or more wheels or bearings or bushings, or any other desired structures. Alternatively, guide members may be formed from combinations of these elements. In preferred embodiments, guide members interact with corresponding guide members mounted on an adjacent conveyor segment, the segment oriented in generally the same direction as the first conveyor segment; such that, for instance, a guide member on one segment constrains, in sliding fashion, portions of legs or other guide members on the other segment from undesired lateral motion.

Preferably, an extendable and retractable conveyor according to certain aspects and embodiments of the present invention includes at least one guide member generally oriented in directions of extension and retraction of the conveyor and at least one guide member not generally oriented in directions of extension and retraction of the conveyor. Such orientation can be important to reducing or eliminating binding between components or segments.

Some guide members may be generally oriented in directions of extension and retraction of the conveyor. It should be understood that these guide members do not have to be precisely oriented in the directions of extension and retraction, although in some embodiments these guide members are. Rather, these guide members' orientation can vary somewhat. Preferably, these guide members are generally oriented to interact with other guide members in such a manner to achieve some of the objects of various embodiments of the present invention.

In some embodiments, guide members generally oriented in the directions of extension and retraction may include rails, side rails, tubes, I-beams, angle irons, flat structures, or any other suitable structure mounted to various portions of conveyor segments, such as, but not limited to legs or conveyor beds.

Other guide members may be generally not oriented in directions of extension and retraction of the conveyor. It should be understood that these guide members do not have to be oriented perpendicularly to the directions of extension and retraction, although in some embodiments these guide members are. Rather, these guide members' orientations can vary somewhat. Preferably, in some embodiments, these guide members are oriented to interact with the guide members generally oriented in the directions of extension and retraction in such a manner to achieve some of the objects of various embodiments of the present invention.

In some embodiments, guide members generally not oriented in the directions of extension and retraction may include portions of legs, structures attached to legs, structures attached to other portions of a conveyor segment, rails, tubes, I-beams, or any other suitable structures.

A guide member on one segment need not cooperate with a guide member on another segment, although it can. In one embodiment, for example, one of the conveyor segments includes at least one guide member generally oriented in the directions of extension and retraction. The at least one guide member may be mounted such that it slidably cooperates with guide members formed by or secured to portions of the other conveyor segment. In some embodiments, the guide members formed by or secured to portions of the other conveyor segment are not oriented generally in the directions of extension and retraction. In some embodiments, the guide members not generally oriented in the directions of extension and retraction are formed by at least some of the legs supporting the conveyor segment. The guide members may be mounted such that the interaction of the guide members is substantially limited to cooperating to guide the extension and/or retraction of the conveyor and not interacting to restrain movements in directions unrelated to extension and/or retraction.

In some aspects and embodiments of the present invention, the at least one guide member generally oriented in the directions of extension and retraction and the at least one guide member not generally oriented in the directions of extension and retraction may cooperate to guide the extension and/or retraction of the conveyor such that the conveyor segments may not jam or bind. The guide members, while cooperating to the extent necessary to guide the conveyor during extension and/or retraction, may not necessarily interact to restrain the movements of the conveyor segments relative to each other in some directions unrelated to the extension and retraction of the conveyor. For example, in some embodiments of the present invention, the conveyor may be extended on a floor that is uneven, causing one conveyor segment to change in elevation relative to the other conveyor segment. The change in elevation may cause some previous extendable conveyors to jam. However, in some aspects and embodiments of the present invention, the guide members, and consequently the conveyor segments, may change somewhat in elevation with respect to each other without the conveyor jamming.

Guide members may be formed by or secured to different portions of the conveyor segments. In some embodiments, guide members which are generally oriented in the directions of extension and retraction may be secured to the side rails of the conveyor beds. In some embodiments, guide members generally oriented in the directions of extension and retraction may be secured to the legs supporting the conveyor bed. The guide members may extend the entire length of the conveyor segment, or along a portion of the conveyor segment.

In some aspects and embodiments, guide members generally not oriented in the directions of extension and retraction may be formed by, or secured to, different portions of the conveyor segments. In some embodiments, guide members generally not oriented in the directions of extension and retraction are formed from at least some of the legs supporting the conveyor bed. In some embodiments, guide members generally not oriented in the directions of extension and retraction may be structures located on at least some of the legs supporting the conveyor bed. In some embodiments, guide members generally not oriented in the directions of extension and retraction may be structures mounted to portions of the conveyor bed. The guide members may be located along only a portion, or along the entire length of the conveyor segment. The exact location and orientation of the guide members generally not oriented in the directions of extension and retraction is not important, all that is important is that the guide members are located such that they may slidably cooperate with portions of the guide member generally oriented in the directions of extension and retraction of the conveyor.

In some aspects and embodiments, extension and/or retraction of the conveyor is guided by the cooperation of guide members generally oriented in the directions of extension and retraction on each conveyor segment. Guide members may be located on at least some of the legs of each conveyor segment such that the guide members slidably cooperate with each other to guide the extension and/or retraction of the conveyor.

In some aspects and embodiments, each conveyor segment may include: at least one guide member generally oriented in the directions of extension and retraction; and at least one guide member not generally oriented in the directions of extension and retraction. The members generally oriented in the directions of extension and retraction may be oriented such that they may slidably cooperate with the members generally not oriented in the directions of extension and retraction of the other conveyor segment to guide the conveyor segments relative to each other during extension and/or retraction.

In some aspects and embodiments, at least one of the conveyor segments may include pivot structures. The pivot structures may be located along each side rail of the conveyor bed proximate the legs. The pivot structures help the legs of the conveyor segment to maintain contact with a floor that is uneven.

In some aspects and embodiments, the conveyor may include more than two conveyor segments formed such that the segments may be at least partially retracted into a nested orientation. Extension and/or retraction of the conveyor may be guided as described above.

In some aspects and embodiments, the conveyor may include transition sections that facilitate packages moving from one conveyor segment to another. A transition section may be formed such that it is attached to an end of one conveyor segment and slidably rests on the top of another conveyor segment.

It is an object and advantage of some aspects and embodiments of the present invention to provide an extendable and retractable conveyor that will not jam or bind during extension and/or retraction, especially when the conveyor is extended and/or retracted on an uneven surface.

It is another object and advantage of some aspects and embodiments of the present invention to provide an extendable and retractable conveyor that is relatively easy and inexpensive to construct and maintain.

Other objects, features and advantages of various embodiments and aspects of the invention are apparent in other portions of this document.

### BRIEF DESCRIPTION OF THE DRAWINGS

FIG. 1 shows an extendable and retractable conveyor according to a first embodiment of the present invention in side elevation, shown in a partially nested orientation.

FIG. 2 is a side elevation view of a portion of the conveyor shown in FIG. 1.

FIG. 3 shows a lower conveyor segment of the conveyor shown in FIG. 1 in side elevation.

FIG. 4 shows an upper conveyor segment of the conveyor shown in FIG. 1 in side elevation.

FIG. 5 shows an extendable and retractable conveyor according to another embodiment of the present invention in front elevation.

FIG. 6 shows an extendable and retractable conveyor according to another embodiment of the present invention in front elevation.

FIG. 7 shows an extendable and retractable conveyor according to another embodiment of the present invention in front elevation.

FIG. 8 shows an extendable and retractable conveyor according to another embodiment of the present invention in front elevation.

FIG. 9 shows an extendable and retractable conveyor according to another embodiment of the present invention in front elevation.

FIG. 10 shows an extendable and retractable conveyor according to another embodiment of the present invention in front elevation.

FIG. 11 shows an extendable and retractable conveyor according to another embodiment of the present invention in front elevation.

FIG. 12 shows an extendable and retractable conveyor according to another embodiment of the present invention in front elevation.

FIG. 13 shows a lower conveyor segment of the conveyor shown in FIG. 5 in front elevation.

FIG. 14 shows an upper conveyor segment of the conveyor shown in FIG. 5 in front elevation.

FIG. 15 shows a portion of an extendable and retractable conveyor according to another embodiment of the present invention in a side view.

FIG. 16 shows the portion of the conveyor shown in FIG. 8 in a front view.

### DETAILED DESCRIPTION

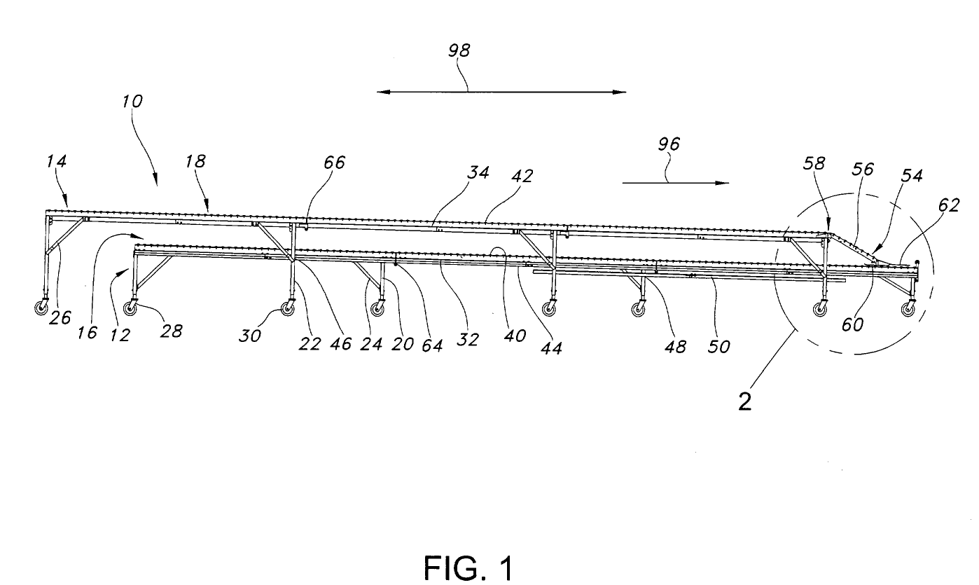

FIG. 1 shows, in a side elevational view, an extendable and retractable conveyor 10 according to a first embodiment of the present invention. Extendable and retractable conveyors 10 may be formed from any number of conveyor segments. In the embodiment shown in FIG. 1, extendable and retractable conveyor 10 includes a lower conveyor segment 12 and an upper conveyor segment 14. Lower conveyor segment 12 and upper conveyor segment 14 are formed such that lower conveyor segment 12 may at least partially nest within upper conveyor segment 14. FIG. 1 shows a conveyor 10 in a partially nested configuration. Extendable and retractable conveyor 10 may be extended and retracted along directions of extension and retraction 98 by moving the conveyor segments 12 and 14 relative to each other along the directions of extension and retraction 98. As shown in FIG. 1, directions of extension and retraction 98 generally correspond or constitute substantially the general direction in which packages or other materials are conveyed on the conveyor 10.

In the embodiment shown in FIG.1, conveyor segments 12 and 14 include conveyor beds 16 and 18 respectively, and a number of legs 20 and 22 respectively. Braces 24 and 26 are secured to the legs 20 and 22 and the conveyor beds 16 and 18 to provide additional support and stability. However, braces 24 and 26 are not necessary. As shown in FIG. 1, conveyor segments 12 and 14 slope slightly downward along a direction of conveyance 96 to facilitate the movement of packages, boxes, and other items typically conveyed on conveyors. The slopes of conveyor segments 12 and 14 are variable because legs 20 and 22 may be adjusted to different heights. However, it is not necessary that conveyor segments 12 and 14 be sloped. Nor is it necessary that legs 20 and 22 be adjustable.

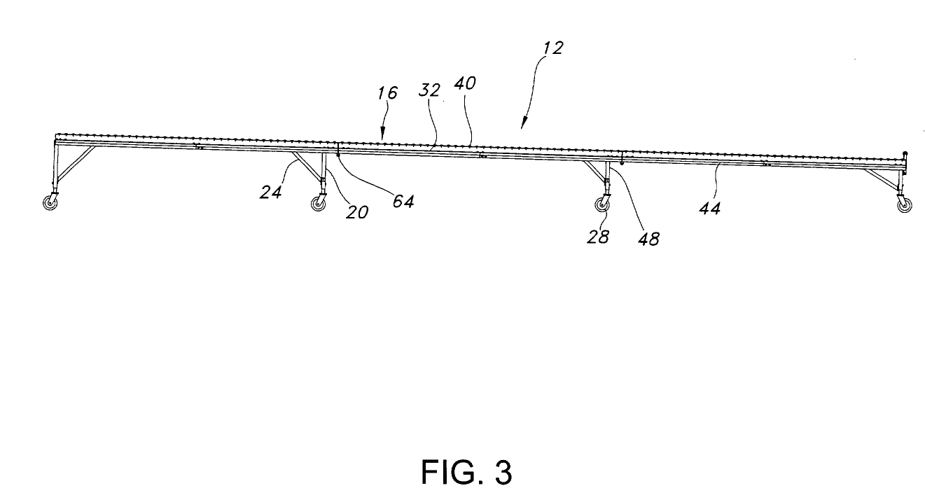

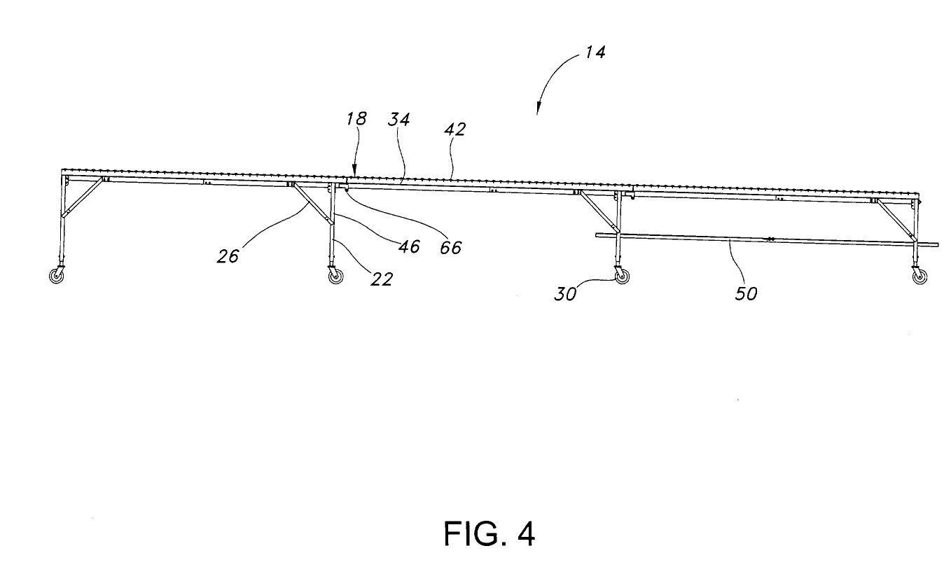

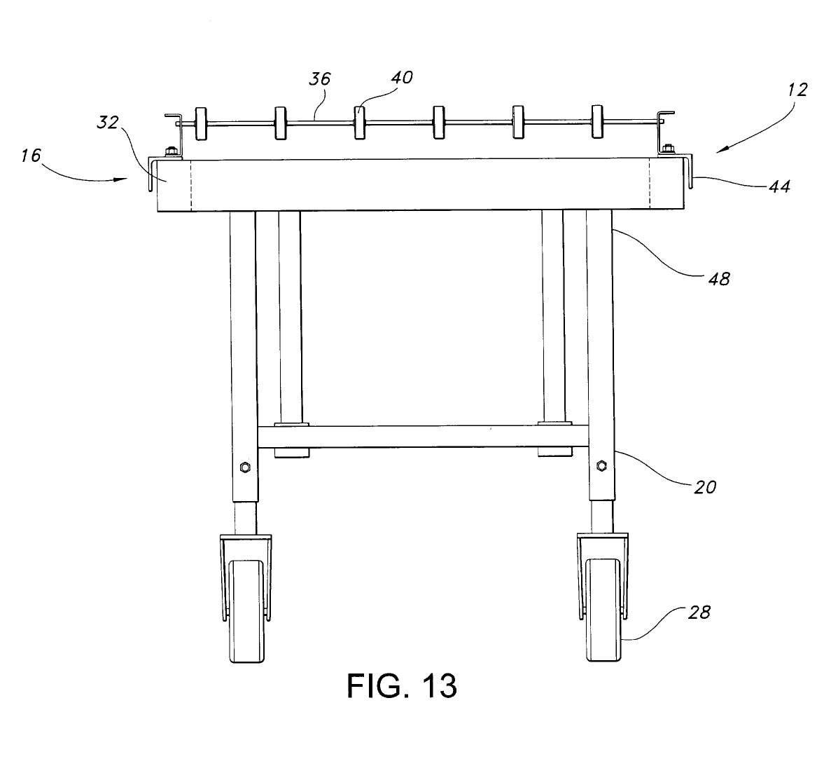

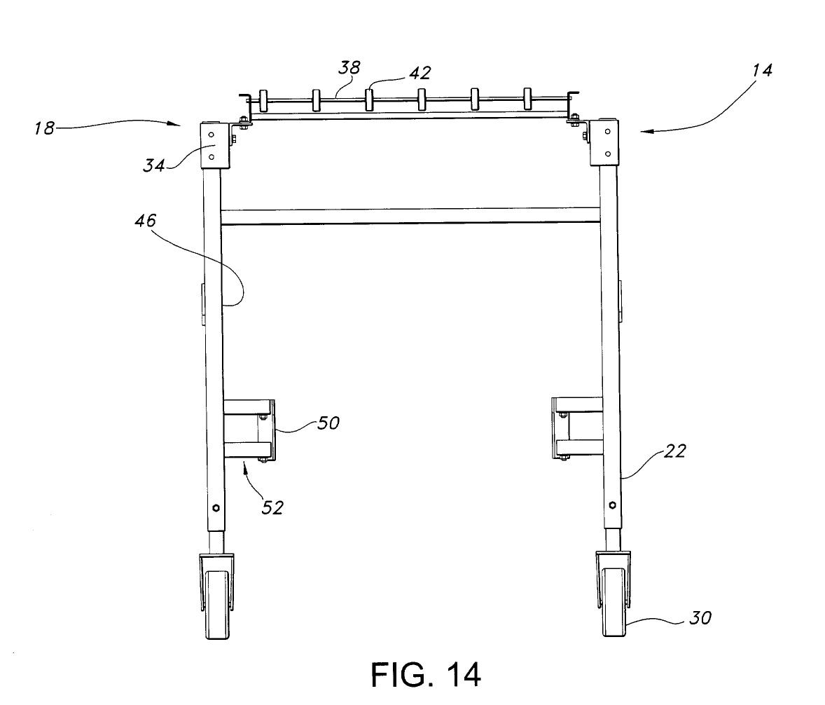

In the embodiments shown in FIGS. 1-14, the upper conveyor segment 14 and the lower conveyor segment 12 are movable relative to one another. It is not necessary that both conveyor segments 12 and 14 be movable. It is only necessary that one conveyor segment is movable relative to another segment. Preferably, conveyor segments 12 and 14 are both movable in directions of extension and retraction 98. Casters 28 and 30 are attached to legs 20 and 22 to facilitate movement of conveyor segments 12 and 14. Casters 28 and 30 may include brake structures, that, when engaged, prevent conveyor segments 12 and 14 from moving. Casters 28 and 30 are not necessary; any suitable structure that facilitates movement may be attached to the bottoms of legs 20 and 22. Preferably, casters 28 are attached to legs 20 to facilitate movement of the conveyor segments 12 and 14.

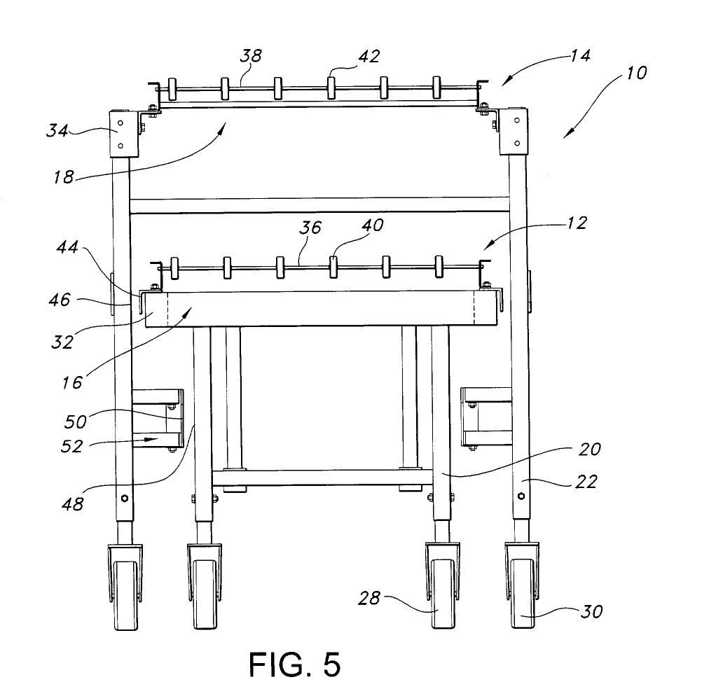

FIG. 5 shows an end view of an alternate embodiment of the extendable and retractable conveyor 10 of FIG. 1. Upper conveyor bed 18 and lower conveyor bed 16 each include a pair of side rails 34 and 32 respectively. A number of axles 38 and 36 respectively span the side rails 34 and 32. A number of skate wheels 42 and 40 are rotatably mounted about the axles. Alternatively, conveyor beds 16 and 18 may include a number of rollers, belts, or any other suitable conveyance structure. Skate wheels 42 and 40, axles 38 and 36, rollers, or belts may be of conventional structure suitably designed to fit the purpose at hand.

In the embodiments illustrated by FIGS. 1 and 5, extension and retraction of conveyor 10 is guided by the cooperation of guide members 44 with 46 and 48 with 50. Lower conveyor segment 12 includes guide members 44. Guide members 44 are generally oriented in the directions of extension and retraction 98, as shown in FIG. 1. As shown in FIG. 5, a guide member 44 is attached to each side rail 32 of lower conveyor bed 16. Guide members 44 extend along the entire length of conveyor bed 16. However, it is not necessary that guide members 44 extend along the entire length; they may extend along only a portion of the length of conveyor bed 16. However, guide member 44 preferably extends along the entire length of conveyor bed 16. In alternative embodiments, guide members 44 are formed by side rails 32 of lower conveyor bed 16.

In the embodiment shown in FIG. 5, guide members 44 slidably cooperate with guide members 46 on upper conveyor segment 14 to guide the conveyor segments 12 and 14 relative to each other during extension and retraction. Guide members 46 are not generally oriented in the directions of extension and retraction. As shown in FIG. 5, guide members 46 happen to constitute portions of legs 22 of upper conveyor segment 14. Guide members 44 slidably cooperate with leg portions 46 such that the conveyor segments 12 and 14 are guided relative to each other during extension and/or retraction. It is not necessary that guide members 46 be formed from portions of upper conveyor legs 22. In alternative embodiments, guide members 46 may be formed from structures attached to legs 22 or structures attached to other portions of upper conveyor segment 14.

As clearly shown in FIG. 5, the cooperation of guide members 46 and 44 will not limit some movements of the conveyor segments 12 and 14 that are unrelated to movements in directions of extension and retraction. For instance, if lower conveyor segment 12 is extended onto a section of flooring with a higher elevation then a section of flooring on which upper conveyor segment 14 rests, lower conveyor segment 12, and consequently guide members 44, will move towards a higher elevation. Guide members 44 and 46 of the present invention may not hinder this movement, unlike some previous conveyors discussed supra.

In the embodiment shown in FIG. 5, guide members 48 and 50, of conveyor segments 12 and 14 respectively, facilitate guiding conveyor segments 12 and 14 relative to each other during extension and retraction. Guide members 50 are generally oriented in the directions of extension and retraction 98, as shown in FIG. 1. Guide members 50 may be attached to supporting structures 52 or directly to legs 22. In the embodiment shown in FIG. 5, guide members 50 are attached to supporting structures 52 which are attached to legs 22. Guide members 50 are mounted along the entire length of upper conveyor segment 38. Alternatively, guide members 50 may extend just along a portion of upper conveyor segment 14. Preferably, guide members 50 are mounted along an end portion of upper conveyor segment 14 as shown in FIG. 1. Guide member 50 may be formed from the same material and in the same manner as guide member 44. However, it is not necessary that guide members 50 be formed from the same material or in the same manner as guide members 44.

In the embodiments shown in FIG. 5, guide members 50 on upper conveyor segment 14 cooperate with guide members 48 on lower conveyor segment 12 to guide conveyor segments 12 and 14 relative to each other during extension and retraction. Guide members 48 generally are not oriented in the directions of extension and retraction 98. In the embodiment shown in FIG. 5, guide members 48 are formed from portions of legs 20 of lower conveyor segment 12. Alternatively, guide members 48 may be formed from structures attached to legs 20 or structures attached to other portions of lower conveyor segment 12. Guide members 50 and 48 cooperate in much the same way as guide members 44 and 46. Moreover, guide members 50 and 48 may not restrict some movements in directions unrelated to the directions of extension and retraction 98 much like guide members 44 and 46. However, the movements unrelated to the directions of extension and retraction 98 unrestricted by guide members 50 and 48 may not necessarily be identical to the movements unrelated to the directions of extension and retraction 98 unrestricted by guide members 44 and 46.

In some embodiments of the present invention, additional guide members may be secured to portions of the floor surfaces where conveyor 10 is used. Such guide members may cooperate with casters 28 to guide the conveyor during extension and/or retraction.

In a preferred embodiment of the present invention, guide members 44, attached to lower conveyor segment side rails 32, slidably cooperate with portions of legs of upper conveyor segment 46; and guide members 50, attached to support structures 52 attached to upper conveyor segment legs 22, slidably cooperate with portions of legs of lower conveyor segment 48; such that conveyor segments 12 and 14 are guided relative to each other during extension and retraction of conveyor 10.

The locations of guide members 44, 46, 48, and 50 shown in FIGS. 1 and 5 are not the only possible locations for guide members to achieve some of the objects and advantages of the present invention. Other locations and configurations for guide members 44, 46, 48, and 50, as well as other guide members, may be chosen to achieve an extendable and retractable conveyor 10 according to certain aspects and embodiments of the present invention.

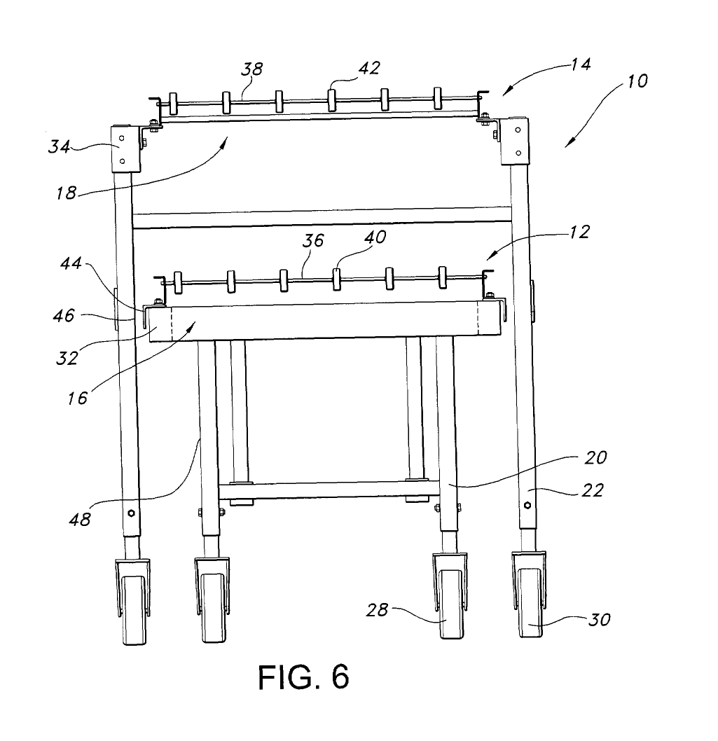

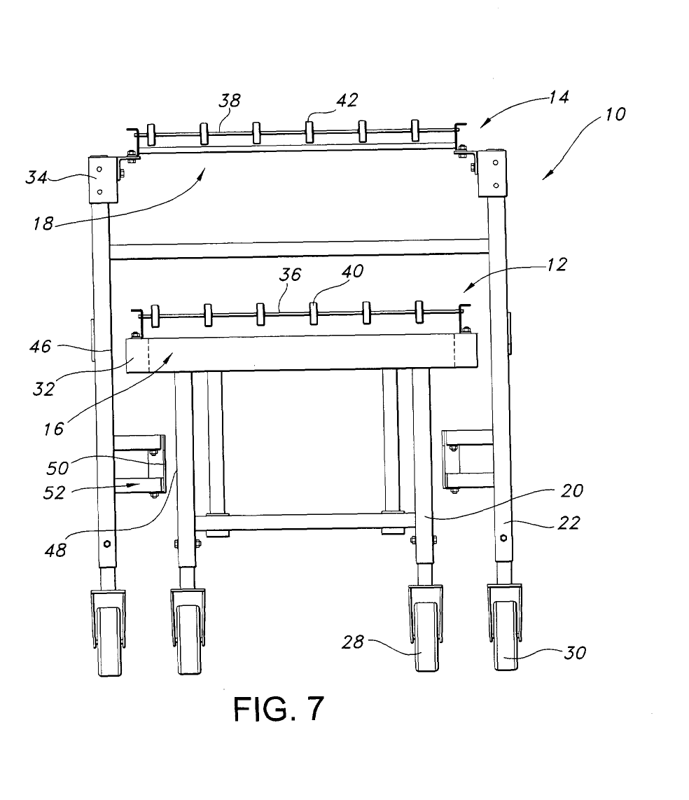

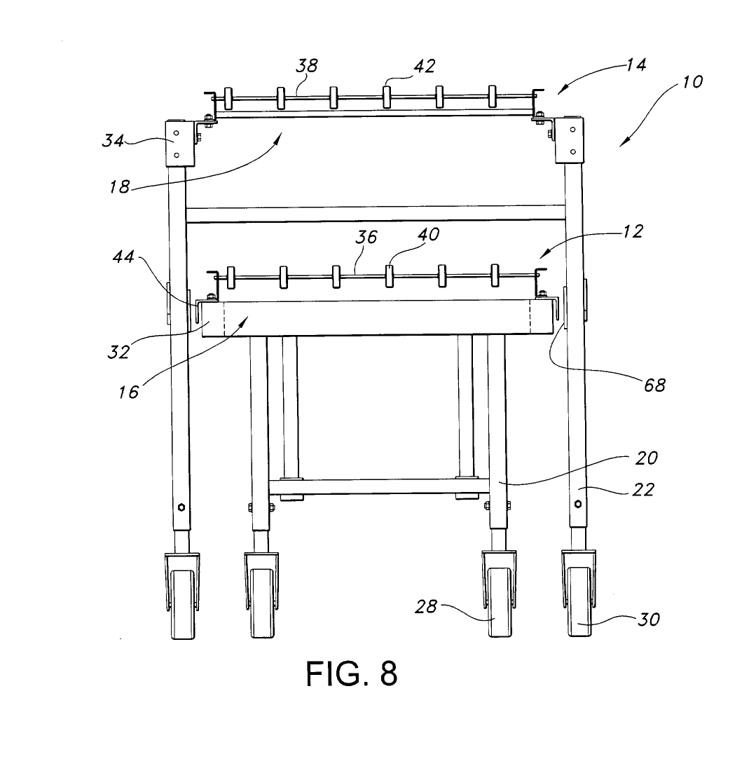

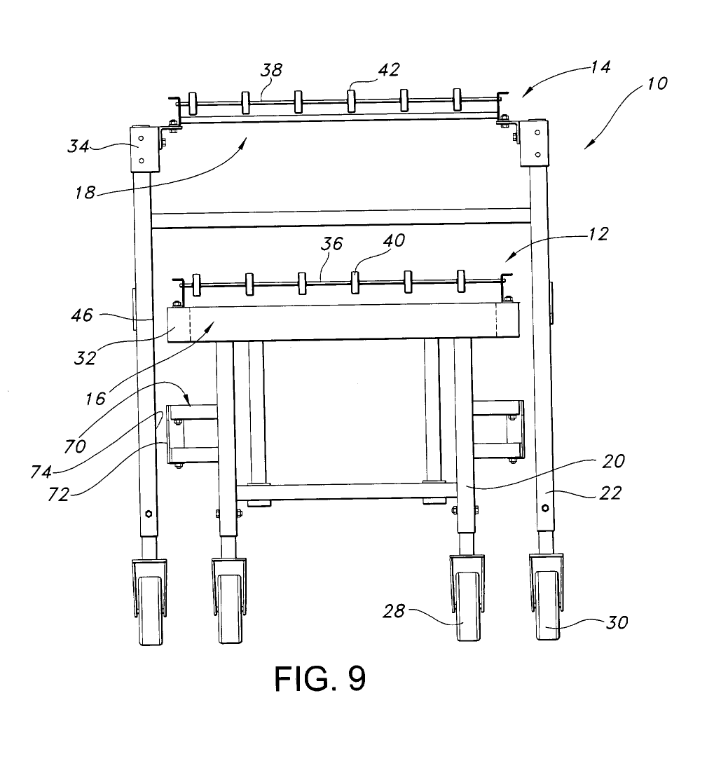

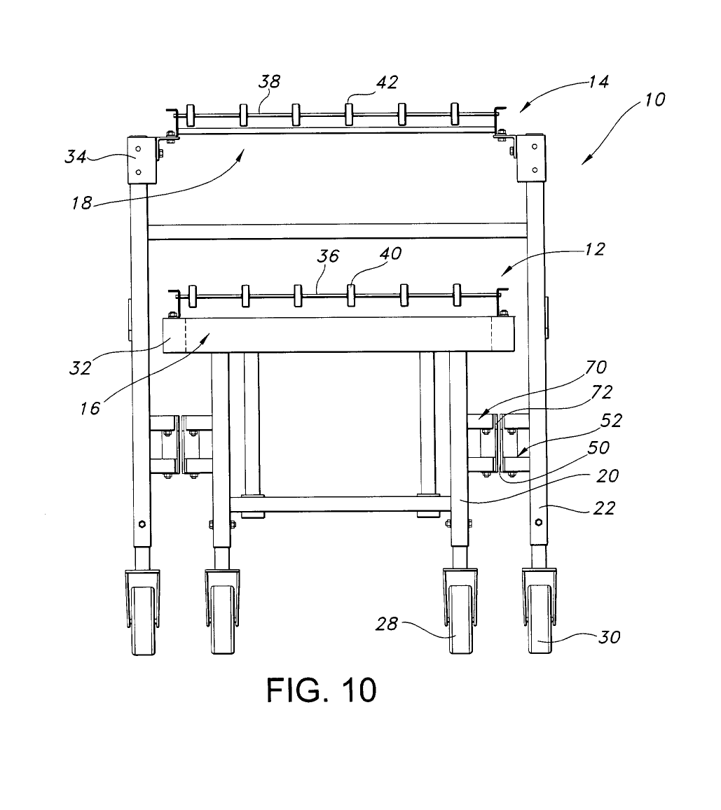

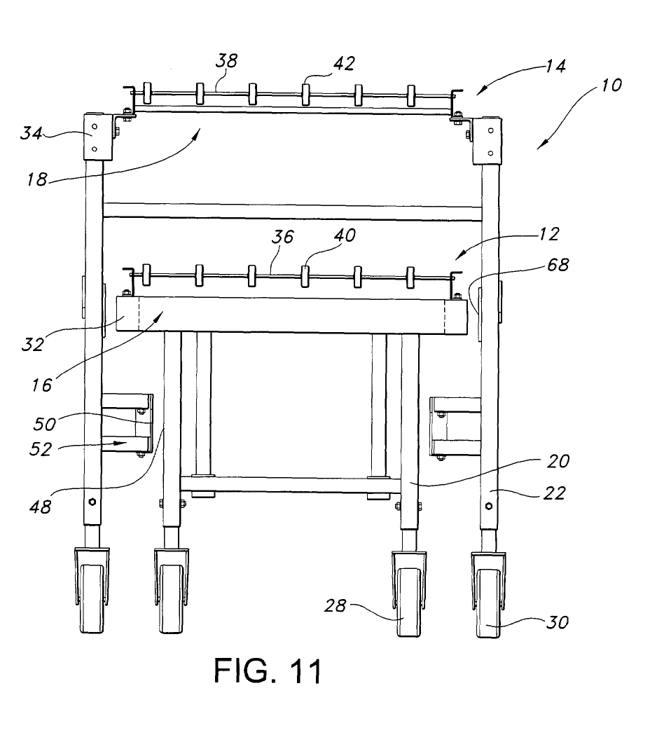

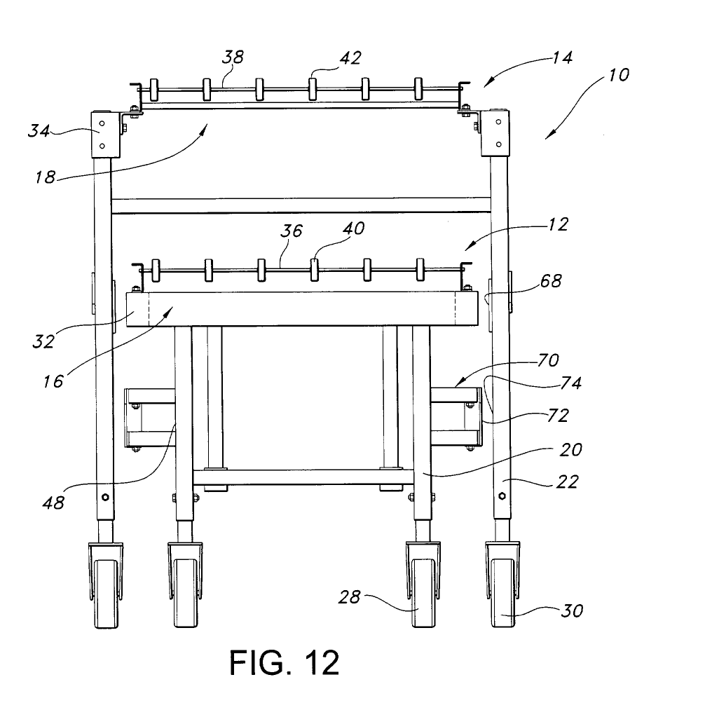

For example, in the embodiment shown in FIG. 6, extension and retraction of conveyor 10 is guided by the cooperation of guide members 44 attached to lower conveyor segment 12 with guide members constituting portions of legs 46 of upper conveyor segment 14. In another embodiment, as shown in FIG. 7, conveyor 10 is guided during extension and retraction by the cooperation of guide members 50 on upper conveyor segment 14 with guide members constituting portions of legs 48 on lower conveyor segment 12. In yet another embodiment, as shown in FIG. 8, conveyor 10 is guided during extension and retraction by the cooperation of guide members 44 attached to lower conveyor segment 12 with guide members 68 attached to upper conveyor segment 14. In yet another embodiment, as shown in FIG. 9, conveyor 10 is guided during extension and retraction by the cooperation of guide members 72 attached to lower conveyor segment 12 with guide members constituting portions of legs 74 attached to upper conveyor segment 14. In yet another embodiment, as shown in FIG. 10, conveyor 10 is guided during extension and retraction by the cooperation of guide members 50 on upper conveyor segment 14 with guide members 72 attached to legs 20 by supporting structure 70 on lower conveyor segment 12. In yet another embodiment, as shown in FIG. 11, conveyor 10 is guided during extension and retraction by the cooperation of guide members 68 on upper conveyor 14 with side rails 32 of lower conveyor segment 12. Guide member 68, as shown in FIG. 11, may be secured to legs 22 and extend along the entire length, or just a portion, of upper conveyor segment 14. Conveyor 10, as shown in FIG. 11, is also guided during extension and retraction by the cooperation of guide members 50 attached to upper conveyor segment 14 with guide members constituting portions of legs 48 attached to lower conveyor segment 12. In yet another embodiment, as shown in FIG. 12, conveyor 10 is guided during extension and retraction by the cooperation of guide members 68 on upper conveyor segment 14 with side rails 32 of lower conveyor segment 12. Conveyor 10, as shown in FIG. 12, is also guided by the cooperation of guide members 72 attached to lower conveyor segment 12 with guide members constituting portions of legs 74 attached to upper conveyor segment 14. As is readily apparent, guide members extending generally in directions of extension and retraction and guide members not extending generally in directions of extension and retraction can be located in many different locations and many different orientations to achieve an extendable and retractable conveyor of the present invention.

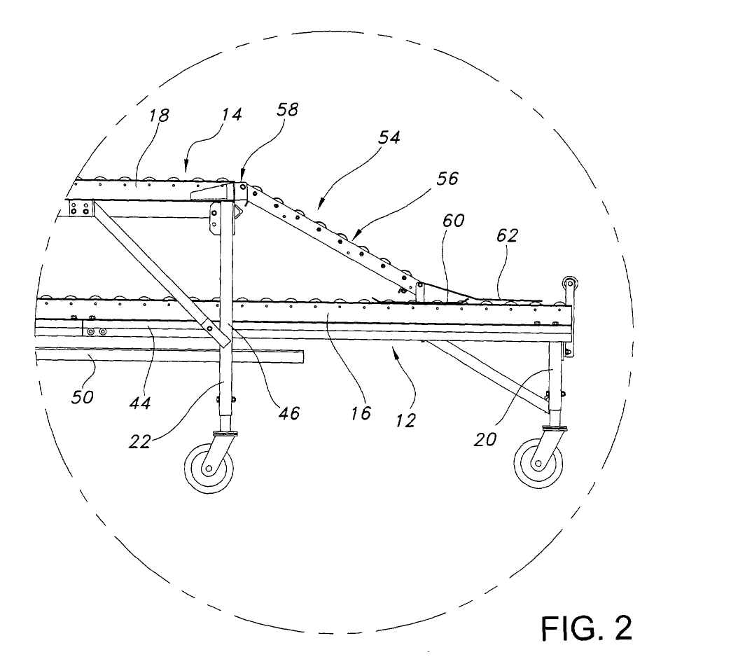

As shown in FIGS. 1 and 2, some embodiments of the present invention may include a transition section 54. Transition section 54 facilitates the movement of packages, boxes, and other items typically conveyed on conveyors from a higher conveyor segment to a lower conveyor segment. In the embodiment shown in FIGS. 1 and 2, the transition section facilitates movement from upper conveyor segment 14 to lower conveyor segment 12. Transition section 54 includes a conveyor bed 56. Conveyor bed 56 may be formed in a similar manner and from similar materials as conveyor beds 16 and 18. However, it is not necessary that conveyor bed 56 be formed in a similar manner as, or from similar materials as, conveyor beds 16 or 18. Conveyor bed 56 is rotatably mounted to upper conveyor segment 14 by a hinge structure 58. Skid plates 60 and slide 62 are attached to conveyor bed 56 such that transition section 54 slidably rests on lower conveyor segment 12. Skid plates 60 slidably rest on upper surfaces of side structures 32. Slide 62 slidably rests on top surfaces of skate wheels 40. Because transition section 54 slidably rests on lower conveyor segment 12, conveyor 10 may be extended and retracted to certain lengths without repositioning transition section 54.

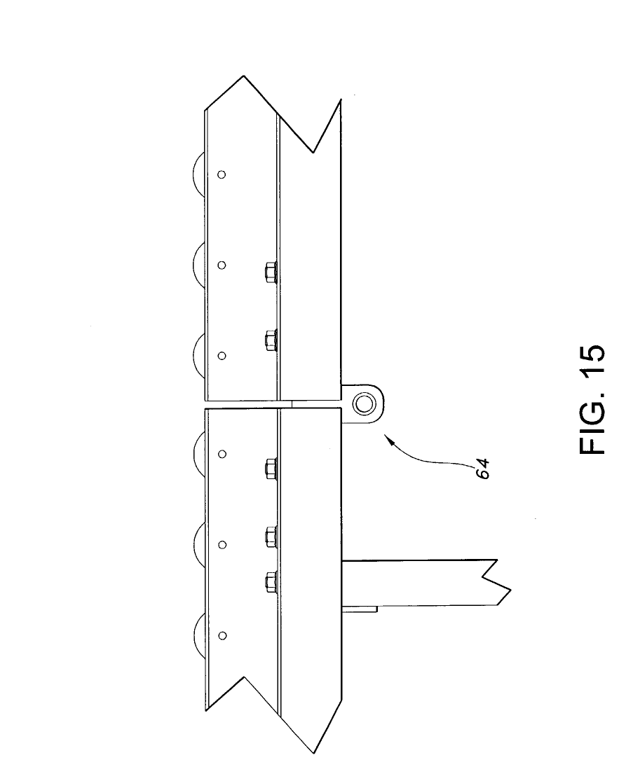

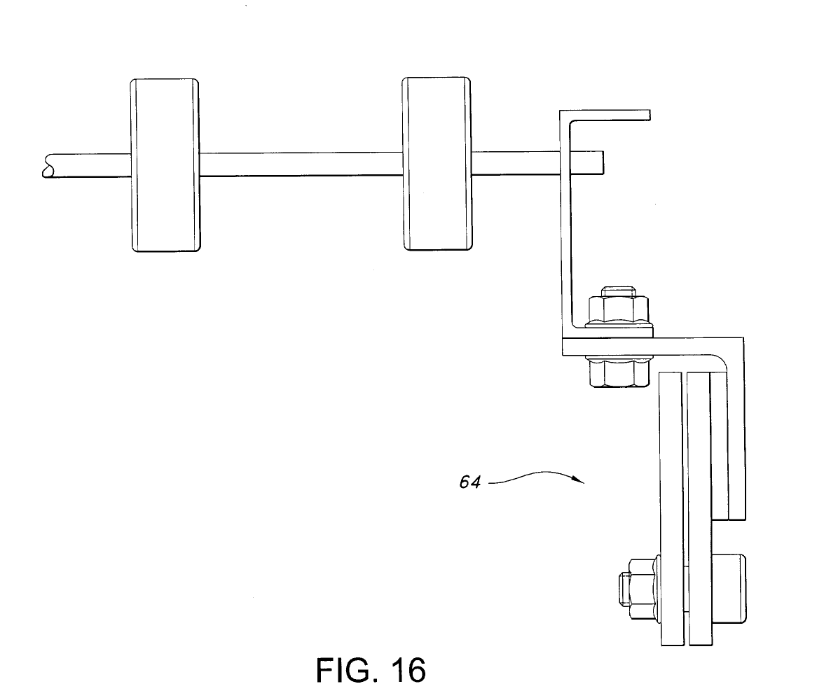

As shown in FIGS. 1, 3, 4, 15, and 16, some embodiments of the present invention include pivot structures 64 and 66 to facilitate conveyor segments 12 and 14 maintaining contact with floor surfaces that are uneven. For instance, portions of a warehouse floor, where an extendable and retractable conveyor according to the present invention may be used, may be situated at different elevations such that a portion of the floor is level with the rear of a truck being loaded or unloaded. Pivot structures 64 and 66 allow casters 28 and 30 to maintain contact with the floor portions situated at different elevations. Pivot structures 64 and 66 are located on side rails 32 and 34 proximate legs 20 and 22. In a preferred embodiment of the present invention, pivot structures 64 and 66 are located on side rails 32 and 34 approximately every ten feet.

In some embodiments of the present invention, lower conveyor segment 12 may include a light and/or fan attachment. The light and/or fan attachment may be mounted underneath a portion of lower conveyor segment 12 that extends into and retracts form a truck, or other carrier, for loading and unloading. The fan aids in providing ventilation or air movement when the lower conveyor segment is extended into the truck. The light provides light when the lower conveyor segment is extended into the truck. The light and/or fan attachment may include an on/off switch.

In some embodiments of the present invention, lower conveyor segment 12 may include a motorized tug. The motorized tug may aid extending and retracting the extendable and retractable conveyor 10.

Changes and modifications, additions and deletions may be made to the structures recited above and shown in the drawings without departing from the scope or spirit of the invention.

1. An extendable and retractable conveyor, comprising: (a) at least two conveyor segments; (b) at least one of the at least two conveyor segments comprising: (i) a conveyor bed; and (ii) a plurality of legs supporting the conveyor bed; (c) at least one conveyor segment adapted to be received in a nesting fashion at least partially by another conveyor segment; (d) at least one conveyor segment movable relative to another conveyor segment; (e) one conveyor segment further comprising at least one first guide member; (f) another conveyor segment further comprising at least one second guide member; (g) the at least one first guide member generally oriented in directions of extension and retraction of the conveyor; (h) the at least one second guide member not generally oriented in the directions of extension and retraction of the conveyor, or channeled with the at least one first guide member; and (i) wherein cooperation of the at least one first guide member with the at least one second guide member facilitates extension and retraction of the conveyor.

2. The conveyor of claim 1, wherein the at least one second guide member comprises portions of the legs supporting the conveyor segment.

3. The conveyor of claim 1, wherein the at least one second guide member further comprises at least one guide structure attached to portions of the conveyor segment.

4. The conveyor of claim 3, wherein the at least one guide structure is attached to at least one of the legs supporting the conveyor segment.

5. The conveyor of claim 1, wherein the at least one first guide member is attached to at least a portion of a side of the conveyor bed of the conveyor segment.

6. The conveyor of claim 1, further comprising: (a) one conveyor segment further comprising at least one third guide member; (b) another conveyor segment further comprising at least one fourth guide member; (c) the at least one third guide member generally oriented in the direction of extension and retraction of the conveyor; (d) the at least one fourth guide member not generally oriented in the direction of extension and retraction of the conveyor; (e) wherein cooperation of the at least one third guide member with the at least one fourth guide member facilitates extension and retraction of the conveyor.

7. The conveyor of claim 6, further comprising: (a) one conveyor segment comprising: (i) the conveyor bed; (ii) the plurality of legs supporting the conveyor bed; (iii) the at least one first guide member; and (iv) the at least one fourth guide member; (b) another conveyor segment comprising: (i) the conveyor bed; (ii) the plurality of legs supporting the conveyor bed; (iii) the at least one second guide member; and (iv) the at least one third guide member; and (c) the conveyor segment partially comprising the first and fourth guide members is adapted to be received in a nesting fashion by the conveyor segment partially comprising the second and third guide members.

8. The conveyor of claim 7, wherein the at least one third guide member is attached to at least one of the plurality of legs supporting the conveyor segment.

9. The conveyor of claim 7, wherein the at least one fourth guide member comprises portions of the plurality of legs supporting the conveyor segment.

10. The conveyor of claim 7, wherein the at least one fourth guide member further comprises guide structures attached to portions of the conveyor segment.

11. The conveyor of claim 10, wherein the guide structures are attached to at least some of the legs supporting the conveyor segment.

12. An extendable and retractable conveyor, comprising: (a) a first conveyor segment, comprising: (i) a conveyor bed; and (ii) a plurality of legs supporting the conveyor bed; (b) a second conveyor segment, comprising: (i) a conveyor bed; (ii) at least one guide member adapted to cooperate with a portion of at least one leg of the first conveyor segment in sliding fashion; and (iii) a plurality of legs supporting the conveyor bed; and (c) wherein (i) one conveyor segment is movable relative to the other conveyor segment; (ii) the second conveyor segment is adapted to be received in nesting fashion at least partially by the first conveyor segment; (iii) the at least one guide member of the second conveyor segment is adapted to guide the conveyor segments relative to each other to permit extension and retraction of the conveyor in a manner that precludes jamming of the conveyor; and (iv) the at least one guide member is not channeled with portions of the first conveyor segment.

13. The conveyor of claim 12, wherein the second conveyor segment further comprises at least two guide members adapted to cooperate with portions of at least two legs of the first conveyor segment in sliding fashion.

14. The conveyor of claim 12, wherein the first conveyor segment is movable relative to the second conveyor segment.

15. The conveyor of claim 12, wherein the second conveyor segment is movable relative to the first conveyor segment.

16. The conveyor of claim 12, wherein the at least one guide member of the second conveyor segment is attached to a side of the conveyor bed of the second conveyor segment.

17. The conveyor of claim 12, wherein the at least one guide member of the second conveyor segment is attached to at least some of the legs of the second conveyor segment.

18. The conveyor of claim 12, further comprising: (a) wherein the first conveyor segment further comprises at least one guide member attached to at least some of the legs of the first conveyor segment; (b) wherein the at least one guide member of the first conveyor segment is adapted to cooperate with at least one leg of the second conveyor segment in sliding fashion; and (c) wherein the at least one guide member of the first conveyor segment is adapted to guide the conveyors relative to each other during extension and retraction in a manner that precludes jamming of the conveyor.

19. The conveyor of claim 18, wherein the at least one guide member of the second conveyor segment is attached to a side of the conveyor bed of the second conveyor segment.

20. The conveyor of claim 18, wherein the at least one guide member of the second conveyor segment is attached to at least some of the legs of the second conveyor segment.

21. The conveyor of claim 20, wherein the at least one guide member of the second conveyor segment is attached to at least some of the legs of the second conveyor segment such that the guide member of the second conveyor segment is adapted to cooperate with the at least one guide member of the first conveyor segment in sliding fashion.

22. The conveyor of claim 12, further comprising: (a) wherein the first conveyor segment further comprises at least one guide member attached to at least some of the legs of the first conveyor segment; (b) wherein the at least one guide member of the first conveyor segment is adapted to cooperate with at least a portion of the conveyor bed of the second conveyor segment in sliding fashion; and (c) wherein the at least one guide member of the first conveyor segment is adapted to guide the conveyor segments relative to each other to permit extension and retraction of the conveyor in a manner that precludes jamming of the conveyor.

23. The conveyor of claim 22, wherein the at least one guide member of the second conveyor segment is attached to at least a portion of the conveyor bed of the second conveyor segment such that the at least one guide member of the second conveyor segment is adapted to cooperate with the at least one guide member of the first conveyor segment in sliding fashion.

24. The conveyor of claim 22, wherein the at least one guide member of the second conveyor segment is attached to at least some of the legs of the second conveyor segment such that the at least one guide member of the second conveyor segment is adapted to cooperate with at least some of the legs of the first conveyor segment in sliding fashion.

25. An extendable and retractable conveyor, comprising: (a) a first conveyor segment, comprising: (i) a conveyor bed; (ii) at least one guide member adapted to cooperate with a portion of at least one leg of a second conveyor segment in sliding fashion; and (iii) a plurality of legs supporting the conveyor bed; (b) wherein the second conveyor segment comprises: (i) a conveyor bed; and (ii) a plurality of legs supporting the conveyor bed; and (c) wherein: (i) one conveyor segment is movable relative to the other conveyor segment; (ii) the second conveyor segment is adapted to be received in a nesting fashion at least partially by the first conveyor segment; (iii) the at least one guide member of the first conveyor segment is adapted to guide the conveyors relative to each other during extension and retraction in a manner that precludes jamming of the conveyor; and (iv) the at least one guide member of the first conveyor segment is not channeled with portions of the second conveyor segment.

26. The conveyor of claim 25, wherein the first conveyor segment further comprises at least two guide members adapted to cooperate with at least two legs of the second conveyor segment in sliding fashion.

27. The conveyor of claim 25, wherein the first conveyor segment is movable relative to the second conveyor segment.

28. The conveyor of claim 25, wherein the second conveyor segment is movable relative to the first conveyor segment.

29. An extendable and retractable conveyor, comprising: (a) a first conveyor segment, comprising: (i) a conveyor bed; (ii) at least one guide member adapted to cooperate with at least a portion of a second conveyor bed of a second conveyor structure in sliding fashion; and (iii) a plurality of legs supporting the conveyor bed; (b) wherein the second conveyor member further comprises a plurality of legs supporting the second conveyor bed; and (c) wherein (i) one conveyor segment is movable relative to the other conveyor segment; (ii) the second conveyor segment is adapted to be received in a nesting fashion at least partially by the first conveyor segment; (iii) the at least one guide member of the first conveyor segment is adapted to guide the conveyor segments relative to each other during extension and retraction in a manner that precludes jamming of the conveyor; and (iv) the at least one guide member of the first conveyor segment is not channeled with portions of the second conveyor segment.

30. The conveyor of claim 29, wherein the first conveyor segment further comprises at least two guide members adapted to cooperate with at least two portions of the conveyor bed of the second conveyor structure in sliding fashion.

31. The conveyor of claim 29, wherein the first conveyor segment is movable relative to the second conveyor segment.

32. The conveyor of claim 29, wherein the second conveyor segment is movable relative to the first conveyor segment.

33. An extendable and retractable conveyor, comprising: (a) a first conveyor segment, comprising: (i) a conveyance means; and (ii) a support means; (b) a second conveyor segment, comprising: (i) a conveyance means; (ii) at least one guide means adapted to cooperate with at least a portion of the support means of the first conveyor segment in sliding fashion; and (iii) a support means; and (c) wherein (i) one conveyor segment is movable relative to the other conveyor segment; (ii) one conveyor segment is adapted to be received in a nesting fashion at least partially by the other conveyor segment, and (iii) the at least one guide means is adapted to guide the conveyor segments relative to each other during extension and retraction in a manner that precludes jamming of the conveyor.

34. The conveyor of claim 33, wherein the first conveyor segment further comprises at least one guide means adapted to cooperate with at least a portion of the support means of the second conveyor segment in sliding fashion.
